(19) United States
(12) Patent Application Publication
(10) Pub. No.: US 2015/0249940 A1
(43) Pub. Date: Sep. 3, 2015

(54) METHOD AND APPARATUS FOR PERFORMING CALL RECOVERY AFTER CALL DROP

(71) Applicant: QUALCOMM Incorporated, San Diego, CA (US)

(72) Inventors: Ming YANG, San Diego, CA (US); Insung KANG, San Diego, CA (US); Qingxin CHEN, Del Mar, CA (US); Tom CHIN, San Diego, CA (US); Shaohong Qu, San Diego, CA (US)

(73) Assignee: QUALCOMM Incorporated, San Diego, CA (US)

(21) Appl. No.: 14/194,313

(22) Filed: Feb. 28, 2014

(51) Int. Cl. H04W 36/04

(52) U.S. Cl. CPC H04W 36/04

(57) ABSTRACT

Aspects of the methods and apparatus relate to performing call recovery after a call drop. A cell selection update procedure may be initiated to recover a call in response to the call being dropped with a serving cell. Link conditions may be determined for the serving cell and for different candidate cells. The aspects of the methods and apparatus also include selecting a cell, based on the link conditions, from among the serving cell and a candidate cell with a highest signal power parameter in a Primary Common Control Physical Channel (PCCPCH) across a set of neighboring frequencies of the different candidate cells. Call recovery may be performed using the selected cell. In some aspects, the highest signal power parameter may be a highest Received Signal Code Power (RSCP).

### BACKGROUND

Aspects of the present disclosure relate generally to wireless communication systems, and more particularly, to cell selection for performing call recovery after a call is dropped.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UNITS Terrestrial Radio Access Network (UTRAN). The UTRAN is the radio access network (RAN) defined as a part of the UMTS, a third generation (3G) mobile phone technology supported by the 3rd Generation Partnership Project (3GPP). The UMTS, which is the successor to Global System for Mobile Communications (GSM) technologies, currently supports various air interface standards, such as Wideband Code Division Multiple Access (W-CDMA), Time Division Code Division Multiple Access (TD-CDMA), and Time Division Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

Generally, optimal cell selection after a call is dropped in a TD-SCDMA environment can be challenging because selecting a suitable cell with the proper connection characteristics can be difficult to do. Thus, there is a need for optimizing the selection of a suitable cell by a user equipment (UE) to recover a dropped call in a TD-SCDMA environment, thereby providing consistent service in a wireless communication system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect, a method for wireless communication includes initiating a cell selection update procedure to recover a call in response to the call being dropped with a serving cell and determining link conditions of the serving cell and different candidate cells. Additionally, the method includes selecting a cell, based on the link conditions, from among the serving cell and a candidate cell with a highest signal power parameter in a Primary Common Control Physical Channel (PCCPCH) across a set of neighboring frequencies of the different candidate cells. Furthermore, the method includes performing call recovery using the selected cell.

In another aspect, an apparatus for wireless communication includes at least one processor and a memory having instructions and coupled to the at least one processor, where the at least one processer is configured to execute the instructions to initiate a cell selection update procedure to recover a call in response to the call being dropped with a serving cell and determine link conditions of the serving cell and different candidate cells. Additionally, the at least one processor is configured to execute the instruction to select a cell, based on the link conditions, from among the serving cell and a candidate cell with a highest signal power parameter in a PCCPCH across a set of neighboring frequencies of the different candidate cells. Furthermore, the at least one processor is configured to perform call recovery using the selected cell.

In another aspect, an apparatus for wireless communication includes means for initiating a cell selection update procedure to recover a call in response to the call being dropped with a serving cell and means for determining link conditions of the serving cell and different candidate cells. Additionally, the apparatus includes means for selecting a cell, based on the link conditions, from among the serving cell and a candidate cell with a highest signal power parameter in a PCCPCH across a set of neighboring frequencies of the different candidate cells. Furthermore, the apparatus includes means for performing call recovery using the selected cell.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of hut a few of the various ways in which the principles of various aspects may be employed, and this description is intended to include all such aspects and their equivalents.

### BRIEF DESCRIPTION OF THE DRAWINGS

FIG. 1 is a schematic diagram illustrating an aspect of a call restoration component in a wireless communication system;

FIG. 2 is a schematic diagram illustrating additional aspects of cell selection in a call restoration;

FIG. 3 is a schematic diagram illustrating a frame structure in TD-SCDMA.

FIG. 4 is a schematic diagram illustrating a more detailed aspect of the components of the call restoration component of FIG. 1;

FIG. 5 is a flow diagram illustrating an aspect of a method of call restoration at a UE in a wireless communication system;

FIG. 6 is a block diagram illustrating aspects of a computer device including a RAT measurement reporting component according to the present disclosure;

FIG. 7 is a block diagram illustrating an example of a hardware implementation for an apparatus employing a processing system executing the call restoration component to perform the functions described herein;

FIG. 8 is a block diagram conceptually illustrating an example of a telecommunications system including a UE configured to perform the functions described herein;

FIG. 9 is a conceptual diagram illustrating an example of an access network for use with a UE configured to perform the functions described herein;

FIG. 10 is a conceptual diagram illustrating an example of a radio protocol architecture for the user and control planes for a base station and/or a UE configured to perform the functions described herein; and

FIG. 11 is a block diagram conceptually illustrating an example of a Node B in communication with a UE in a telecommunications system configured to perform the functions described herein.

### DETAILED DESCRIPTION

The detailed description set forth below in connection with the appended drawings is intended as a description of various configurations and is not intended to represent the only configurations in which the concepts described, herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Generally, Time Division Synchronous Code Division Multiple Access (TD-SCDMA) is one option in 3G wireless communication cellular networks. TD-SCDMA is based on time division and code division to allow multiple mobile stations or UEs to share the same radio bandwidth. The downlink transmission and uplink transmission from the UE to a network share the same bandwidth while utilizing different time slots (TSs) within the bandwidth.

According to various aspects of 3GPP, after a call is dropped with a network, a UE moves to an idle mode. Thereafter, when the UE attempts to recover the call and moves from the idle mode to a connected, mode with the network, the UE selects a suitable cell to camp on. For example, the UE aligns to a time slot (TS) of a cell, the UE then utilizes the received scrambling code identification to obtain the Common Pilot Channel (CPICH) and camps on the cell.

However, if no suitable cell is found, the UE may utilize the stored information associated with a cell selection update procedure in order to find a suitable cell to camp on. By utilizing the cell selection update procedure, the UE may then select a cell to camp on which requires the least amount of time for call recovery. Preferably, the UE would like to camp on the most previous cell since the UE may already have the network reserve resource codes for quick call recovery. However, the UE may utilize the cell selection update procedure and select a different cell (e.g., a neighboring cell) to camp on if call recovery with the different cell can occur more quickly than call recovery with the cell being used when the call was dropped.

As such, there is a need for optimizing cell selection of a suitable cell by a UE for call recovery of a dropped call in a TD-SCDMA environment, thereby decreasing the time required for call recovery of a dropped call.

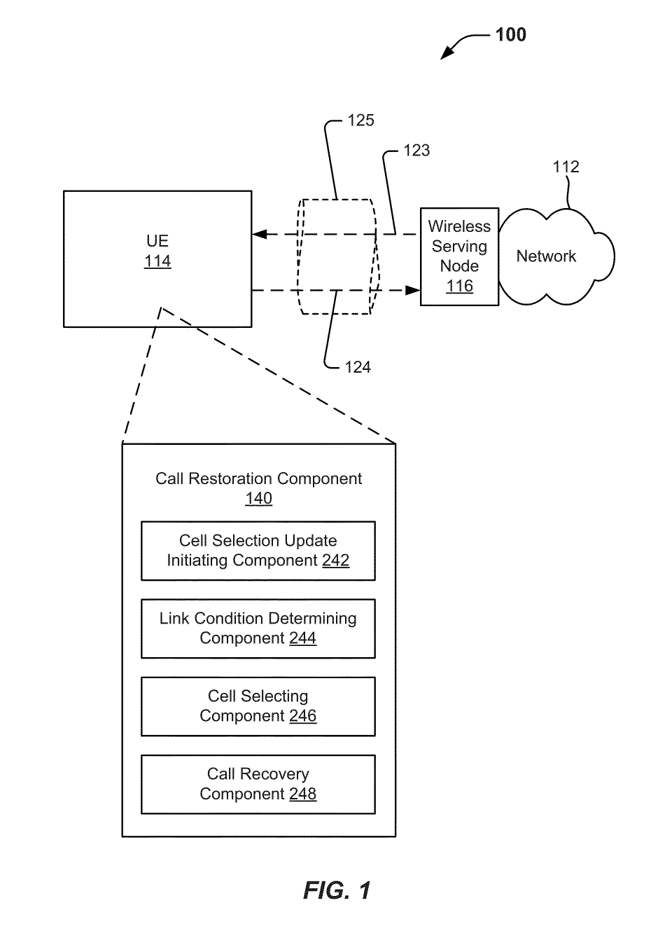

Referring to FIG. 1, in one aspect, a wireless communication system 100 is configured to facilitate communicating data between a mobile device and a network. Wireless communication system 100 includes at least one UE 114 that may communicate wirelessly with network 112 via a respective one or more serving nodes, including, but not limited to, wireless serving node 116 over one or more wireless link 125. The network 112 may represent one or more networks in communication with the wireless serving node 116. The one or more wireless links 125, may include, but are not limited to, signaling radio bearers and/or data radio bearers. Wireless serving node 116 may be configured to transmit one or more signals 123 to UE 114 over the one or more wireless links 125, and/or LIE 114 may transmit one or more signals 124 to wireless serving node 116. In an aspect, signals 123 and signals 124 may include, but are not limited to, one or more messages, which may transmit data and/or signaling between the UE 114 and the network 112 via wireless serving node 116.

According to the present aspects, UE 114 may further include a call restoration component 140 configured to optimize cell selection of a suitable cell for call recovery of a dropped call. For example, in an aspect, call restoration component 140 may be configured to initiate a cell selection update procedure to recover a dropped call, determine link conditions of the serving cell being used when the call was dropped and different candidate cells, select a cell form among the serving cell and the candidate cells based on the link conditions, and perform call recovery with the selected cell.

UE 114 may comprise a mobile apparatus and may be referred to as such throughout the present disclosure. Such a mobile apparatus or UE 114 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology.

UE 114 may include a call restoration component 140 that may be configured, among other things, to include a cell selection update initiating component 242 that is configured to or includes means for initiating a cell selection update procedure to recover a call in response to the call being dropped with a serving cell. Call restoration component 140 may also include a link condition determining component 244 that is configured to or includes means for determining link conditions of the serving cell and of different candidate cells.

In another aspect, call restoration component 140 may include a cell selecting component 246 that is configured to or includes means for selecting a cell, based on the link conditions, from among the serving cell and a candidate cell with a highest signal power parameter in a Primary Common Control Physical Channel (PCCPCH) across a set of neighboring frequencies of the different candidate cells. The highest signal power parameter may be a highest Received Signal Code Power (RSCP), for example. Additionally, call restoration component 140 may include a call recovery component 248 that is configured to or includes means for performing call recovery using the selected cell. In some aspects, the functions and/or operations of any one of the components described above for call restoration component 140 may be included or performed by one or more of the other components of call restoration component 140.

Additionally, the one or more wireless nodes, including, but not limited to, wireless serving node 116 of wireless communication system 100, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 100 may include one or more small base stations, such as, but not limited to a femtocell, picocell, microcell, or any other small base station.

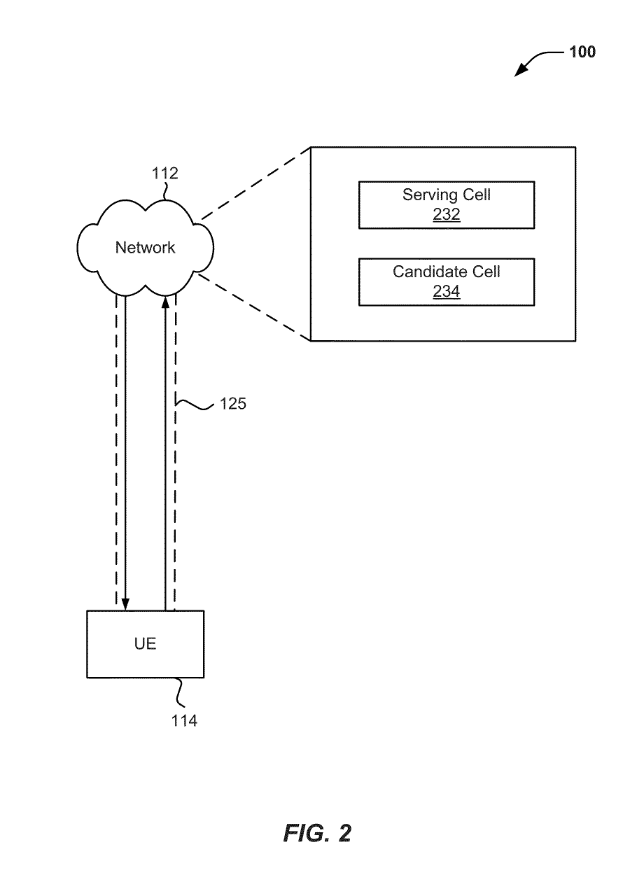

Referring to FIG. 2, in an aspect of the present apparatus and method, the wireless communication system 100 of FIG. 1 may be configured to support communications between a number of users, where one or more of those users can perform optimized cell selection of a suitable cell for call recovery of a dropped call. FIG. 2 illustrates a manner in which network 112 communicates with one user over wireless link 125. In one aspect, the user may be UE 114 having the call restoration component 140. The wireless communication system 100 can be configured for downlink transmission (e.g., data, control information) as represented by the arrow from network 112 to UE 114. The wireless communication system 100 can be configured for uplink transmission (e.g., data, control information) as represented by the arrow from UE 114 to network 112.

In an aspect, within network 112 may reside serving cell 232 that communicates with UE 114 over wireless link before a call is dropped. Additionally, within network 112 resides candidate cell 234 that may communicate with UE 114 after a cell selection update procedure. It should be noted that there may be a plurality of candidate cells 234 to choose from when UE 114 performs the cell selection update procedure. The plurality of candidate cells 234 may include at least one neighbor cell to the serving cell 232. Moreover, there may be instances in which the serving cell 232 may be more suitable than candidate cell 234 and may be selected. to communicate with the UE 114 after the cell selection update procedure.

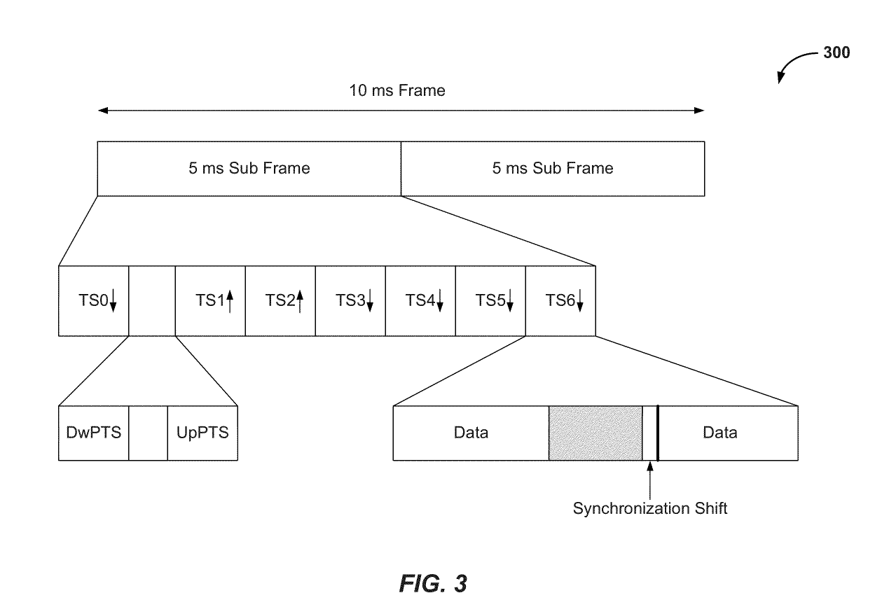

FIG. 3 is a schematic diagram illustrating the structure of a frame 300. Frame 300, or similar frame structures, may be used for TD-SCDMA applications as well as for other types of wireless communications protocols. Frame 300 has a duration of ten (10) milliseconds (ms), divided into two five (5) ms sub-frames. Each sub-frame may have multiple time slots (TSs) that may be used to communicate different types of information. As shown in FIG. 3, a sub-frame may include a first time slot (TS0), other time slots (TS1, TS2, TS3, TS4, TS5, and TS6) different from the first time slot, as well as a Downlink Pilot Time Slot (DwPTS) and an Uplink Pilot Time Slot (UpPTS), The information in the various time slots of a sub-frame may include, but need not be limited to, information regarding connection conditions to a network (e.g., network 112), traffic information (e.g., data) of a call between a UE (e.g., UE 114) and a network (e.g., network 112), and synchronization information.

Unlike WCDMA, where the CPICH and the Dedicated Physical Channel (DPCH) (e.g., the traffic channel) are located on the same frequency and time slots, PCCPCH and DPCH for TD-SCDMA may be located on different time slots. They may even be located on same or different frequencies. For example, PCCPCH in TD-SCDMA may be located on the first time slot (TS0) of a frame on a primary frequency, while DPCH may be located on a time slot different from TS0 (non-TS0), such as TS3 through TS6, on a working frequency.

By having PCCPCH and DPCH for TD-SCDMA located on different time slots and different frequencies, it may be possible to optimize the selection of a suitable cell by a UE for call recovery of a dropped call. For example, the evaluation of a suitable cell for call recovery may include evaluating a signal power parameter (e.g., Received Signal Code Power (RSCP)) of the PCCPCH on TS0 and primary frequency, as well the RSCP on the non-TS0 and working frequency.

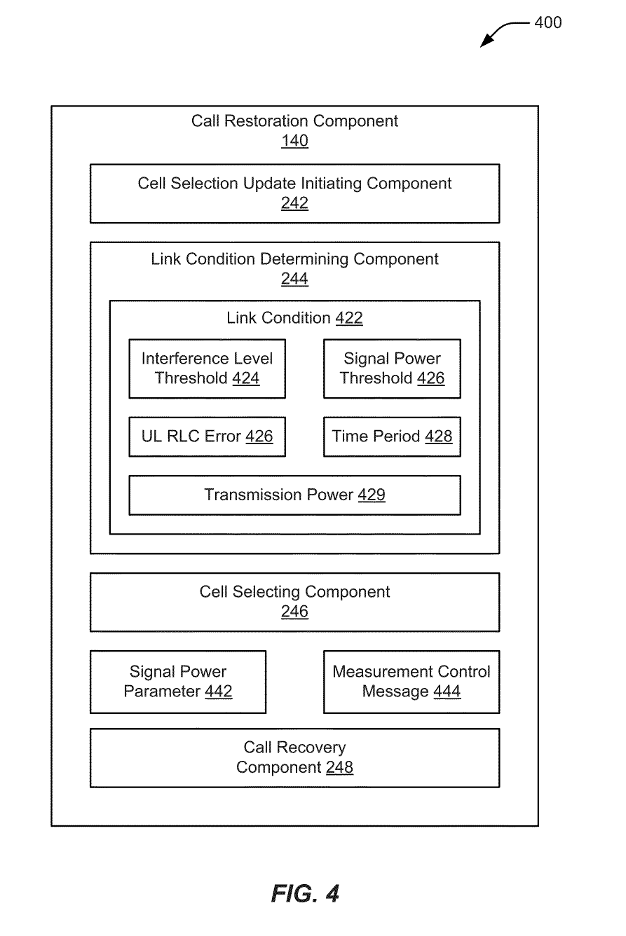

Referring to FIG. 4, a diagram 400 is shown having a more detailed aspect of the call restoration component 140 of UE 114 (FIGS. 1 and 2). In this example, the call restoration component 140 may include additional components that intemperate to, for example, optimize cell selection of a suitable cell for call recovery of a dropped call. In an aspect, call restoration component 140 may be configured, among other things to include the cell selection update initiating component 242 (FIG. 1) capable of initiating a cell selection update procedure to recover a call in response to the call being dropped with a serving cell. For example, when UE 114 drops a call with serving cell 232 (FIG. 2), cell selection update initiating component 242 initiates a cell selection update procedure. The cell selection update procedure is then utilized by UE 114 to select a cell from among the serving cell 232 and a candidate cell 234 among different candidate cells (e.g., neighbor cells).

In another aspect, call restoration component 140 may be configured to include the link condition determining component 244 (FIG. 1), which determines link conditions of the serving cell and of different candidate cells. For example, after initiating the cell selection update procedure, link condition determining component 244 may determine link conditions 422. The link conditions 422 may include information about serving cell 232 and/or candidate cell 234. In an aspect, the link conditions 422 may include, but is not limited to, an interference level 423 having interference information of serving cell 232 and/or candidate cell 234, a signal power 425 having signal power information of serving cell 232 and/or candidate cell 234, an uplink Radio Link Control (RCL) error 427 for the uplink transmission to network 112, a time period 428 of maximum uplink transmission to network 112, and a transmission power 429 having transmission power information of serving cell 232 and/or candidate cell 234.

In yet another aspect, call restoration component 140 may be configured to include the cell selecting component 246 (FIG. 1), which selects a cell, based on the link conditions 422, from among the serving cell (e.g., serving cell 232) and a candidate cell (e.g., candidate cell 234) with a highest signal power parameter 442 (e.g., RSCP) in a PCCPCH across a set of neighboring frequencies of the different candidate cells. The set of neighboring frequencies for different candidate cells may be indicated by measurement control message information 444 received before the call is dropped with the serving cell.

As such, by utilizing the measurement control message information 444 after determining the link conditions 422 of serving cell 232 and candidate cell 234, cell selecting component 246 may then select a cell from among candidate cell 234 and serving cell based on the link conditions 422.

In another aspect, call restoration component 140 may be configured to include the call recovery component 248 (FIG. 1), which performs call recovery using the cell selected by cell selecting component 246. For example, after selecting a cell from among serving cell 232 and candidate cell 234 based on the link conditions 422, call recovery component 248 performs call recovery using serving cell 232 or candidate cell 234.

In yet another aspect, link condition determining component 244 may be configured to determine that an interference level for a working frequency of serving cell 232 on a time slot in a frame (e.g., TS3 through TS6 in FIG. 3) different from the first time slot in the frame (e.g., TS0 FIG. 3), as indicated for an Interference Signal Code Power (ISCP), is greater than interference level threshold 424. For example, link condition determining component 244 may determine that the interference level of a non-TS0 on the TD-SCDMA traffic channel (DPCH) frames for serving cell 232, as described above with reference to FIG. 3, may be greater than interference level threshold 424.

Upon determining that interference level of a non-TS0 for serving cell 232 is greater than interference level threshold 424, cell selecting component 246 may then select candidate cell 234 with the highest signal power parameter in the PCCPCH across the set of neighboring frequencies from among the different candidate cells to be the selected cell for call recovery. Namely, cell selecting component 246 may select candidate cell 234, from among different candidate cells, which has the highest RSCP in the PCCPCH to be the selected cell to perform call recovery by call recovery component 248 when the interference level on the non-TS0 for the working frequency of serving cell 232 is greater than interference level threshold 424.

In another implementation instance, link condition determining component 244 may be configured to determine that an interference level for a working frequency of serving cell 232 on a time slot in a frame (e.g., TS3 through TS6 in FIG. 3) different from the first time slot in the frame (e.g., TS0 FIG. 3), as indicated for an Interference Signal Code Power (ISCP), is greater than interference level threshold 424, and that PCCPCH signal power parameter on the TSP for a primary frequency is greater than a signal power threshold 426. For example, link condition determining component 244 may determine that the interference level of a non-TS0 on the TD-SCDMA traffic channel (DPCH) frames for serving cell 232, as described above with reference to FIG. 3, may be less than interference level threshold 424 and may determine that PCCPCH RSCP on T30 is greater than signal power threshold 426.

Upon determining that interference level of a non-TS0 for serving cell 232 is less than interference level threshold 424 and determining that KETCH RSCP on TS0 is greater than signal power threshold 426, cell selecting component 246 may then select serving cell 232 for call recovery. Namely, cell selecting component 246 may select serving cell 232 to perform call recovery by call recovery component 248 when the interference level of a non-TS0 for a working frequency of serving cell 232 is less than interference level threshold 424 and when PCCPCH RSCP on the TS0 is greater than signal power threshold 426.

In yet another implementation instance, link condition determining component 244 may be configured to determine that a call is dropped with serving cell 232 when uplink RLC error 427 occurs or when transmitting at a maximum transmission power 429 for the time period 428. Upon determining that the call drop with serving cell 232 is based on uplink RLC error 427 or if UE 114 is transmitting to serving cell 232 at the maximum transmission power 429 for time period 428, cell selecting component 246 may then select candidate cell 234 with the highest signal power parameter in the PCCPCH across the set of neighboring frequencies from among the different candidate cells for call recovery.

Namely, cell selecting component 246 may select candidate cell 234, from among different candidate cells, which has the highest RSCP in the PCCPCH to perform call recovery by call recovery component 248 when the call dropped is based on uplink RLC error 427 or when the call is dropped because UE 114 is transmitting at the maximum transmission power 429 for time period 428.

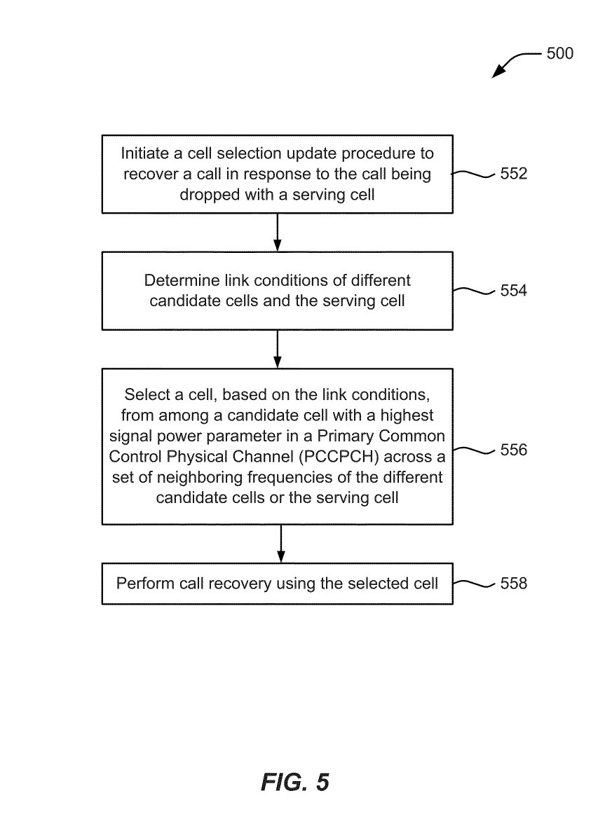

FIG. 5 is a flow diagram illustrating an aspect of a method 500 of the wireless communication system of FIGS. 1 and 2. Method 500 may be performed by, for example, call restoration component 140 of UE 114. At 552, method 500 includes initiating a cell selection update procedure to recover a call in response to the call being dropped with a serving cell. For example, after a call is dropped with serving cell 232, cell selection update initiating component 242 initiates a cell selection update procedure.

At 554, method 500 includes determining link conditions of the serving cell and different candidate cells. For example, after initiating the cell selection update procedure, link condition determining component 244 may then be configured to determine the link conditions 422 of serving cell 232 and/or candidate cell 234. By analyzing the link condition of both serving cell 232 and candidate cell 234 from among different candidate cells, it may be possible to optimize or improve the selection of a suitable cell by a UE for call recovery of a dropped call.

At 556, method 500 includes selecting a cell, based on the link conditions, from among the serving cell and a candidate cell with a highest signal power parameter in a PCCPCH across a set of neighboring frequencies of the different candidate cells. For example, after determining link conditions 422 of serving cell 232 and candidate cell 234, cell selecting component 246 may then select a cell from among the serving cell 232 and candidate cell 234 based on those link conditions 422.

In one aspect, cell selecting component 246 may select candidate cell 234, from among different candidate cells, which has the highest RSCP in the PCCPCH when the interference level on the non-TS0 for the working frequency of serving cell 232 is greater than interference level threshold 424.

In another aspect, cell selecting component 246 may select serving cell 232 when the interference level of a non-TS0 for a working frequency of serving cell 232 is less than interference level threshold 424 and when PCCPCH RSCP on the TS0 is greater than signal power threshold 426.

In yet another aspect, cell selecting component 246 may select candidate cell 234, from among different candidate cells, which has the highest RSCP in the PCCPCH is based on uplink RLC error 427 or when UE 114 is transmitting at the maximum transmission power 429 for time period 428.

At 558, method 500 includes performing call recovery using the selected cell. For example, after cell selecting component 246 selects serving cell 232 or candidate cell 234, call recovery component 248 performs call recovery on serving cell 232 or candidate cell 234, whichever one was selected.

In an aspect, for example, method 500 may be operated by UE 114 (FIGS. 1 and 2) executing call restoration component 140 (FIGS. 1, 2, and 4), or respective sub-components thereof.

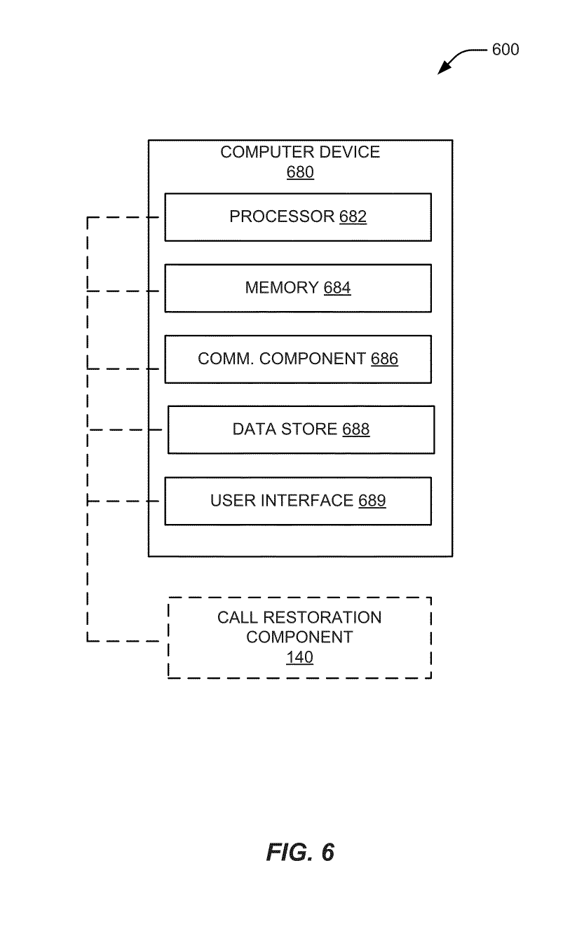

Referring to FIG. 6, there is shown a diagram 600 in which, in one aspect, UE 114 with call restoration component 140 (FIGS. 1, 2, and 4) may be represented by a specially programmed or configured computer device 680. In one aspect, computer device 680 may include call restoration component 140, such as in a specially programmed computer readable instructions or code, firmware, hardware, or some combination thereof. Computer device 680 includes a processor 682 for carrying out processing functions associated with one or more of components and functions described herein, such as cell selection update initiating component 242, link condition determining component 244, cell selecting component 246, and call recovery component 248. Processor 682 can include a single processor or multi-core processor or a set of processors or multi-core processors. Moreover, processor 682 can be implemented as an integrated processing system and/or a distributed. processing system.

Computer device 680 further includes a memory 684, such as for storing data used herein and/or local versions of applications being executed by processor 682. Memory 684 can include any type of memory usable by a computer, such as random access memory (RAM), read only memory (ROM), tapes, magnetic discs, optical discs, volatile memory, non-volatile memory, and any combination thereof.

Further, computer device 680 includes a communications component (comm. component) 686 that provides the necessary functionality for establishing and maintaining communications with one or more parties utilizing hardware, software, and services as described herein. Communications component 686 may carry communications between components on computer device 680, as well as between computer device 680 and external devices, such as devices located across a communications network and/or devices serially or locally connected to computer device 680. For example, communications component 686 may include one or more buses (not shown), and may further include transmit chain components and receive chain components (not shown) associated with a transmitter and receiver, respectively, or a transceiver, operable for interfacing with external devices.

Additionally, computer device 680 may further include a data store 688, which can be any suitable combination of hardware and/or software, that provides for mass storage of information, databases, and programs employed in connection with aspects described herein. For example, data store 688 may be a repository of data and/or other information for determining a suitable cell when a call is dropped with a serving cell. In some aspects, data store 688 may be used as a repository of information used by one or more of the components of call restoration component 140. In other aspects, data store 688 may be a data repository for applications not currently being executed by processor 682 and/or any threshold values or finger position values.

Computer device 680 may additionally include a user interface component 689 operable to receive inputs from a user of computer device 680 and further operable to generate outputs for presentation to the user. User interface component 689 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 689 may include one or more output devices, including but not limited to a display, a speaker, a haptic feedback mechanism, a printer, any other mechanism capable of presenting an output to a user, or any combination thereof.

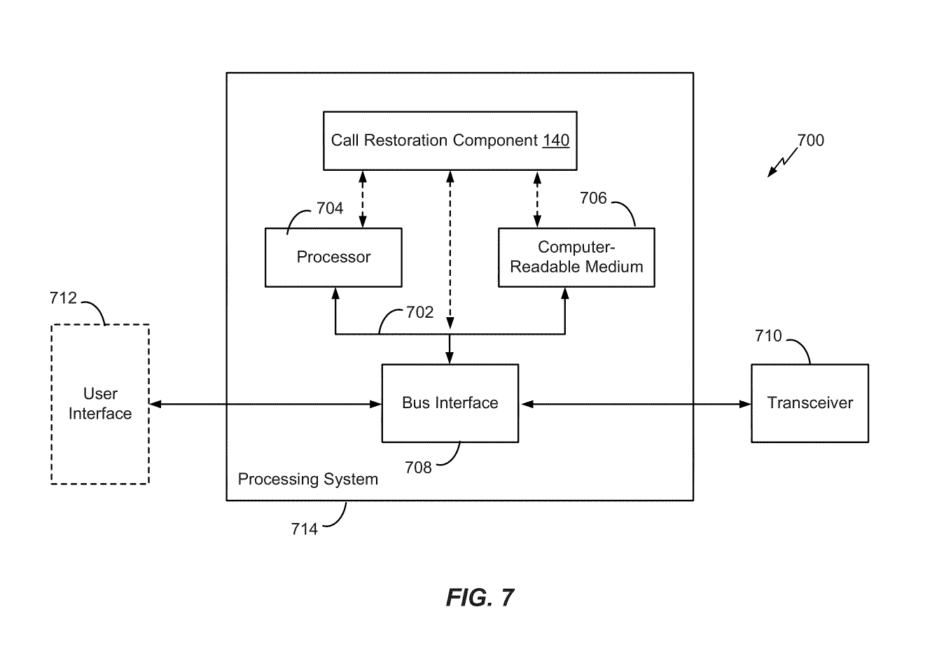

FIG. 7 is a block diagram illustrating an example of a hardware implementation for an apparatus 700 including call restoration component 140 (FIGS. 1, 2, and 4), employing a processing system 714. Processing system 714 may be used for carrying out aspects of the present disclosure, such as method 500 for optimizing cell selection of a suitable cell by a UE, (e.g., UE 114 of FIG. 1) for call recovery of a dropped call in, for example, a TD-SCDMA environment. Processing system 714 may be implemented with bus architecture, represented generally by a bus 702. The bus 702 may include any number of interconnecting buses and bridges depending on the specific application of the processing system 714 and the overall design constraints. The bus 702 links together various circuits including one or more processors, represented generally by the processor 704, computer-readable media, represented generally by the computer-readable medium 706, and one or more components described herein, such as, but not limited to, call restoration component 140 (FIGS. 1, 2, and 4). The bus 702 may also link various other circuits such as timing sources, peripherals, voltage regulators, and power management circuits, which are well known in the art, and therefore, will not be described any further. A bus interface 708 provides an interface between the bus 702 and a transceiver 710. The transceiver 710 provides a means for communicating with various other apparatus over a transmission medium. Depending upon the nature of the apparatus, a user interface 712 (e.g., keypad, display, speaker, microphone, joystick) may also be provided.

The processor 704 is responsible for managing the bus 702 and general processing, including the execution of software stored on the computer-readable medium 706. The software, when executed by the processor 704, causes the processing system 714 to perform the various functions described infra for any particular apparatus. The computer-readable medium 706 may also be used for storing data that is manipulated by the processor 704 when executing software.

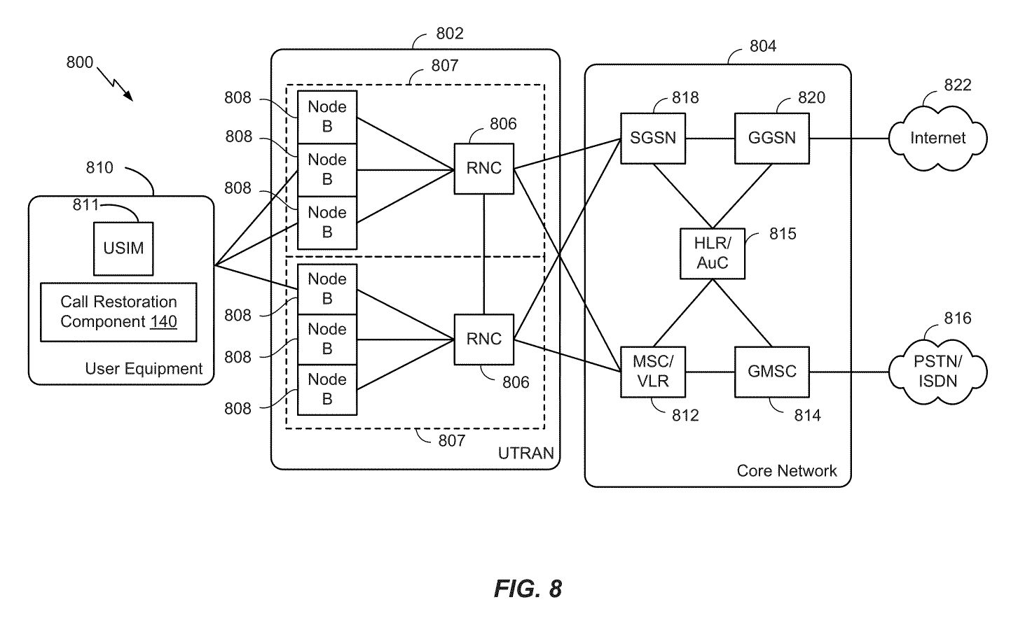

Referring to FIG. 8, by way of example and without limitation, the aspects of the present disclosure are presented with reference to a UMTS system 800 employing a W-CDMA air interface. A UMTS network includes three interacting domains: a Core Network (CN) 804, a UMTS Terrestrial Radio Access Network (UTRAN) 802, and UE 810. UE 810 may be an example of UE 114 and may be configured to include, for example, call restoration component 140 (FIGS. 1, 2, and 4) for optimizing selection of a suitable cell for call recovery of a dropped call. In this example, the UTRAN 802 provides various wireless services including telephony, video, data, messaging, broadcasts, and/or other services. The UTRAN 802 may include a plurality of Radio Network Subsystems (RNSs) such as an RNS 807, each controlled by a respective Radio Network Controller (RNC) such as an RNC 806. Here, the UTRAN 802 may include any number of RNCs 806 and RNSs 807 in addition to the RNCs 806 and RNSs 807 illustrated herein. The RNC 806 is an apparatus responsible for, among other things, assigning, reconfiguring and releasing radio resources within the RNS 806. The RNC 806 may be interconnected to other RNCs (not shown) in the UTRAN 802 through various types of interfaces such as a direct physical connection, a virtual network, or the like, using any suitable transport network.

Communication between a UE 810 and a Node B 808 may be considered as including a physical (PHY) layer and a medium access control (MAC) layer. Further, communication between a UE 810 and an RNC 806 by way of a respective Node B 808 may be considered as including a radio resource control (RRC) layer. As used herein, the PHY layer may be considered layer 1, the MAC layer may be considered layer 2, and the RRC layer may be considered layer 3. Information herein may utilize terminology introduced in the RRC Protocol Specification, 3GPP TS 24.331, incorporated herein by reference.

The geographic region covered by the RNS 807 may be divided into a number of cells, with a radio transceiver apparatus serving each cell. A radio transceiver apparatus is commonly referred to as a Node B in UNITS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 808 are shown in each RNS 807; however, the RNSs 807 may include any number of wireless Node Bs. The Node Bs 808 provide wireless access points to a CN 804 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (OPS) device, a multimedia device, a video device, a digital audio player (e.g., MP3 player), a camera, a game console, or any other similar functioning device. The UE 810 is commonly referred to as a UE in UMTS applications, but may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. In a UMTS system, the UE 810 may further include a universal subscriber identity module (USIM) 811, which contains a user's subscription information to a network. For illustrative purposes, one UE 810 is shown in communication with a number of the Node Bs 808. The downlink (DL), also called the forward link, refers to the communication link from a Node B 808 to a UE 810, and the uplink (UL), also called the reverse link, refers to the communication link from a UE 810 to a Node B 808.

The CN 804 interfaces with one or more access networks, such as the UTRAN 802. As shown, the CN 804 is a GSM core network. However, as those skilled, in the art will recognize, the various concepts presented throughout this disclosure may be implemented in a RAN, or other suitable access network, to provide UEs with access to types of CNs other than GSM networks.

The CN 804 includes a circuit-switched (CS) domain and a packet-switched (PS) domain, Some of the circuit-switched elements are a Mobile services Switching Centre (MSC), a Visitor location register (VLR) and a Gateway MSC. Packet-switched elements include a Serving GPRS Support Node (SGSN) and a Gateway GPRS Support Node (GGSN). Sonic network elements, like EIR, HLR, VLR and AuC may be shared by both of the circuit-switched and packet-switched domains. In the illustrated example, the CN 804 supports circuit-switched services with a MSC 812 and a GMSC 814. In sonic applications, the GMSC 814 may be referred to as a media gateway (MGW). One or more RNCs, such as the RNC 806, may be connected to the MSC 812. The MSC 812 is an apparatus that controls call setup, call routing, and UE mobility functions. The MSC 812 also includes a VLR that contains subscriber-related information for the duration that a UE is in the coverage area of the MSC 812. The GMSC 814 provides a gateway through the MSC 812 for the UE to access a circuit-switched network 816. The GMSC 814 includes a home location register (HLR) 814 containing subscriber data, such as the data reflecting the details of the services to which a particular user has subscribed. The HLR is also associated. with an authentication center (AuC) that contains subscriber-specific authentication data. When a call is received for a particular UE, the GMSC 814 queries the HLR 814 to determine the UE's location and forwards the call to the particular MSC serving that location.

The CN 804 also supports packet-data services with a serving GPRS support node (SGSN) 818 and a gateway GPRS support node (GGSN) 820. GPRS, which stands for General Packet Radio Service, is designed to provide packet-data services at speeds higher than those available with standard circuit-switched data services. The GGSN 820 provides a connection for the UTRAN 802 to a packet-based network 822. The packet-based network 822 may be the Internet, a private data network, or some other suitable packet-based network. The primary function of the GGSN 820 is to provide the UEs 810 with packet-based network connectivity. Data packets may be transferred between the GGSN 820 and the UEs 810 through the SGSN 818, which performs primarily the same functions in the packet-based. domain as the MSC 812 performs in the circuit-switched domain.

An air interface for UMTS may utilize a spread spectrum Direct-Sequence Code Division Multiple Access (DS-CDMA) system. The spread spectrum DS-CDMA spreads user data through multiplication by a sequence of pseudorandom bits called chips. The “wideband” W-CDMA air interface for UMTS is based on such direct sequence spread spectrum technology and additionally calls for a frequency division duplexing (FDD). FDD uses a different carrier frequency for the UL and DL between a Node B 808 and a UE 810. Another air interface for UMTS that utilizes DS-CDMA, and uses time division duplexing (TDD), is the TD-SCDMA air interface. Those skilled, in the art will recognize that although various examples described herein may refer to a W-CDMA air interface, the underlying principles may be equally applicable to a TD-SCDMA air interface.

An HSPA air interface includes a series of enhancements to the 3G/W-CDMA air interface, facilitating greater throughput and reduced latency. Among other modifications over prior releases, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink, or EUL).

HSDPA utilizes as its transport channel the high-speed downlink shared. channel (HS-DSCH). The HS-DSCH is implemented by three physical channels: the high-speed physical downlink shared channel (HS-PDSCH), the high-speed shared control channel (HS-SCCH), and the high-speed dedicated physical control channel (HS-DPCCH).

Among these physical channels, the HS-DPCCH carries the HARQ ACK/NACK signaling on the uplink to indicate whether a corresponding packet transmission was decoded successfully. That is, with respect to the downlink, the UE 810 provides feedback to the node B 808 over the HS-DPCCH to indicate whether it correctly decoded a packet on the downlink.

HS-DPCCH further includes feedback signaling from the UE 810 to assist the node B 808 in taking the right decision in terms of modulation and coding scheme and precoding weight selection, this feedback signaling including the CQI and PCI.

“HSPA Evolved” or HSPA+ is an evolution of the HSPA standard that includes MIMO and 84-QAM, enabling increased throughput and higher performance. That is, in an aspect of the disclosure, the node B 808 and/or the UE 810 may have multiple antennas supporting MIMO technology. The use of MIMO technology enables the node B 808 to exploit the spatial domain to support spatial multiplexing, beamforming, and transmit diversity.

Multiple Input Multiple Output (MIMO) is a term generally used to refer to multi-antenna technology, that is, multiple transmit antennas (multiple inputs to the channel) and multiple receive antennas (multiple outputs from the channel). MIMO systems generally enhance data transmission performance, enabling diversity gains to reduce multipath fading and increase transmission quality, and spatial multiplexing gains to increase data throughput.

Spatial multiplexing may be used to transmit different streams of data simultaneously on the same frequency. The data steams may be transmitted to a single UE 810 to increase the data rate, or to multiple UEs 810 to increase the overall system capacity. This is achieved by spatially precoding each data stream and then transmitting each spatially precoded stream through a different transmit antenna on the downlink. The spatially precoded data streams arrive at the UE(s) 810 with different spatial signatures, which enables each of the UE(s) 810 to recover the one or more the data streams destined for that UE 810. On the uplink, each UE 810 may transmit one or more spatially precoded data streams, which enables the node B 808 to identify the source of each spatially precoded data stream.

Spatial multiplexing may be used when channel conditions are good. When channel conditions are less favorable, beamforming may be used to focus the transmission energy in one or more directions, or to improve transmission based on characteristics of the channel. This may be achieved by spatially precoding a data stream for transmission through multiple antennas. To achieve good coverage at the edges of the cell, a single stream beamforming transmission may be used in combination with transmit diversity.

Generally, for MIMO systems utilizing n transmit antennas, n transport blocks may be transmitted simultaneously over the same carrier utilizing the same channelization code. Note that the different transport blocks sent over the n transmit antennas may have the same or different modulation and coding schemes from one another.

On the other hand, Single Input Multiple Output (SIMO) generally refers to a system utilizing a single transmit antenna (a single input to the channel) and multiple receive antennas (multiple outputs from the channel). Thus, in a SIMO system, a single transport block is sent over the respective carrier.

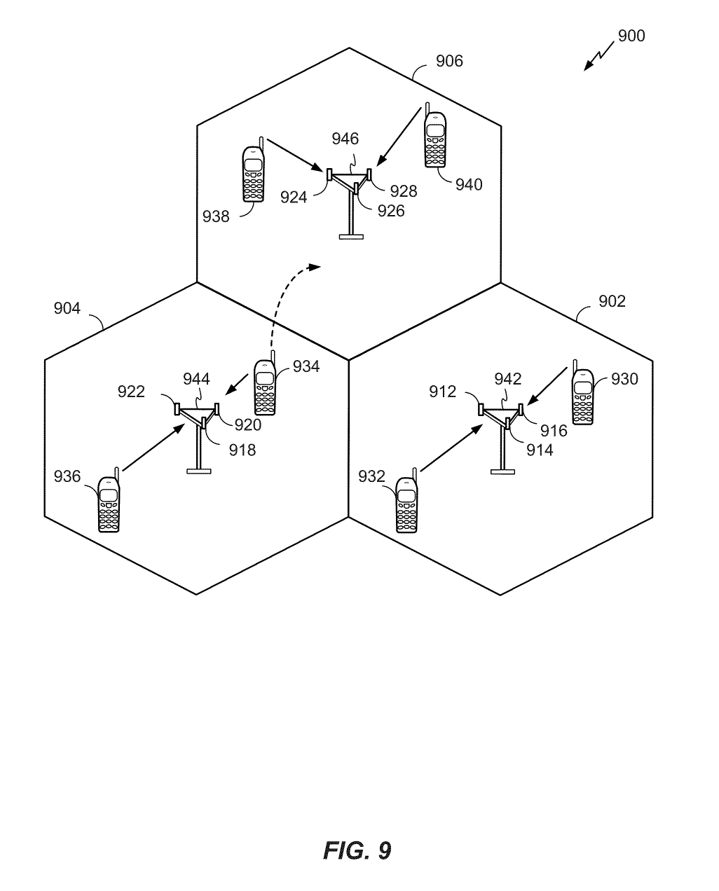

Referring to FIG. 9, an access network 900 in a UTRAN architecture is illustrated. The access network 900 may be part of the wireless communication system 100 of FIGS. 1 and 2. The multiple access wireless communication system includes multiple cellular regions (cells), including cells 902, 904, and 906, each of which may include one or more sectors. The multiple sectors can be formed by groups of antennas with each antenna responsible for communication with UEs in a portion of the cell. For example, in cell 902, antenna groups 912, 914, and 916 may each correspond to a different sector. In cell 904, antenna croups 918, 920, and 922 each correspond to a different sector. In cell 906, antenna groups 924, 926, and 928 each correspond to a different sector. The cells 902, 904 and 906 may include several wireless communication devices, e.g., User Equipment or UEs, which may be in communication with one or more sectors of each cell 902, 904 or 906. For example, UEs 930 and 932 may be in communication with Node B 942, UEs 934 and 936 may be in communication with Node B 944, and UEs 938 and 940 can be in communication with Node B 946. Here, each Node B 942, 944, 946 is configured to provide an access point to a CN 804 (see FIG. 8) for all the UEs 930, 932, 934, 936, 938, 940 in the respective cells 902, 904, and 906. UEs 930, 932, 934, 936, 938, and 940 may be configured to include, for example, call restoration component 140 (FIGS. 1-2, and 3) for optimizing cell selection of a suitable cell by the UE for call recovery of a dropped call in, for example, a TD-SCDMA environment.

As the UE 934 moves from the illustrated location in cell 904 into cell 906, a serving cell change (SCC) or handover may occur in which communication with the UE 934 transitions from the cell 904, which may be referred to as the source cell, to cell 906, which may be referred to as the target cell. Management of the handover procedure may take place at the UE 934, at the Node Bs corresponding to the respective cells, at radio network controller 806 (see FIG. 8), or at another suitable node in the wireless network. For example, during a call with the source cell 904, or at any other time, the UE 934 may monitor various parameters of the source cell 904 as well as various parameters of neighboring cells such as cells 906 and 902. Further, depending on the quality of these parameters, the UE 934 may maintain communication with one or more of the neighboring cells. During this time, the UE 934 may maintain an Active Set, that is, a list of cells that the UE 934 is simultaneously connected to (i.e., the UTRA cells that are currently assigning a downlink dedicated physical channel DPCH or fractional downlink dedicated physical channel F-DPCH to the UE 934 may constitute the Active Set).

The modulation and multiple access scheme employed by the access network 900 may vary depending on the particular telecommunications standard being deployed. By way of example, the standard may include Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband. Internet access to mobile stations. The standard may alternately be Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), and Flash-OFDM employing OFDMA. CDMA2000 and UMB are described in documents from the 3GPP2 organization. The actual wireless communication standard and the multiple access technology employed will depend on the specific application and the overall design constraints imposed on the system.

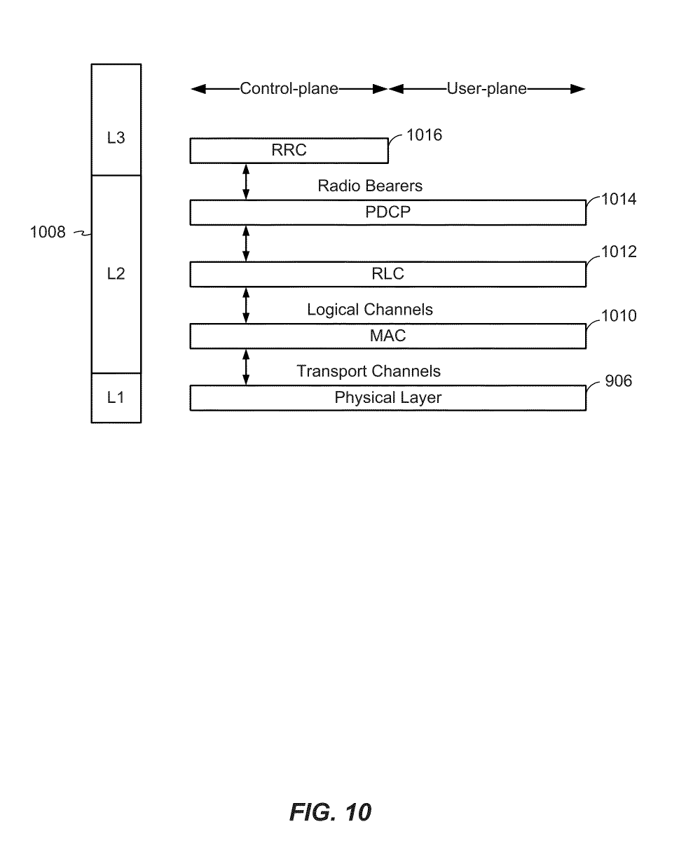

The radio protocol architecture may take on various forms depending on the particular application. An example for an HSPA system will now be presented with reference to FIG. 10.

FIG. 10 is a conceptual diagram illustrating an example of the radio protocol architecture 1000 for the user plane and the control plane of a user equipment (UE) or node B/base station. For example, architecture 1000 may be included in a network entity and/or UE such as an entity within network 112 and/or UE 114 (FIGS. 1 and 2). The radio protocol architecture 1000 for the UE and node B is shown with three layers 1008: Layer 1, Layer 2, and Layer 3. Layer 1 is the lowest lower and implements various physical layer signal processing functions. As such, Layer 1 includes the physical layer 1006. Layer 2 (L2 layer) is above the physical layer 1006 and is responsible for the link between the UE and node B over the physical layer 1006. Layer 3 (L3 layer) includes a radio resource control (RRC) sublayer 1016. The RRC sublayer 1016 handles the control plane signaling of Layer 3 between the UE and the UTRAN.

In the user plane, the L2 layer includes a media access control (MAC) sublayer 1010, a radio link control (RLC) sublayer 1012, and a packet data convergence protocol (PDCP) sublayer 1014, which are terminated at the node H on the network side. Although not shown, the UE may have several upper layers above the L2 layer including a network layer (e.g., IP layer) that is terminated at a PDN gateway on the network side, and an application layer that is terminated at the other end of the connection (e.g., far end UE, server, etc.).

The PDCP sublayer 1014 provides multiplexing between different radio bearers and logical channels, The PDCP sublayer 1014 also provides header compression for upper layer data packets to reduce radio transmission overhead, security by ciphering the data packets, and handover support for UEs between node Bs. The RLC sublayer 1012 provides segmentation and reassembly of upper layer data packets, retransmission of lost data packets, and reordering of data packets to compensate for out-of-order reception due to hybrid automatic repeat request (HARQ). The MAC sublayer 1010 provides multiplexing between logical and transport channels. The MAC sublayer 1010 is also responsible for allocating the various radio resources (e.g., resource blocks) in one cell among the UEs. The MAC sublayer 1010 is also responsible for HARQ operations.

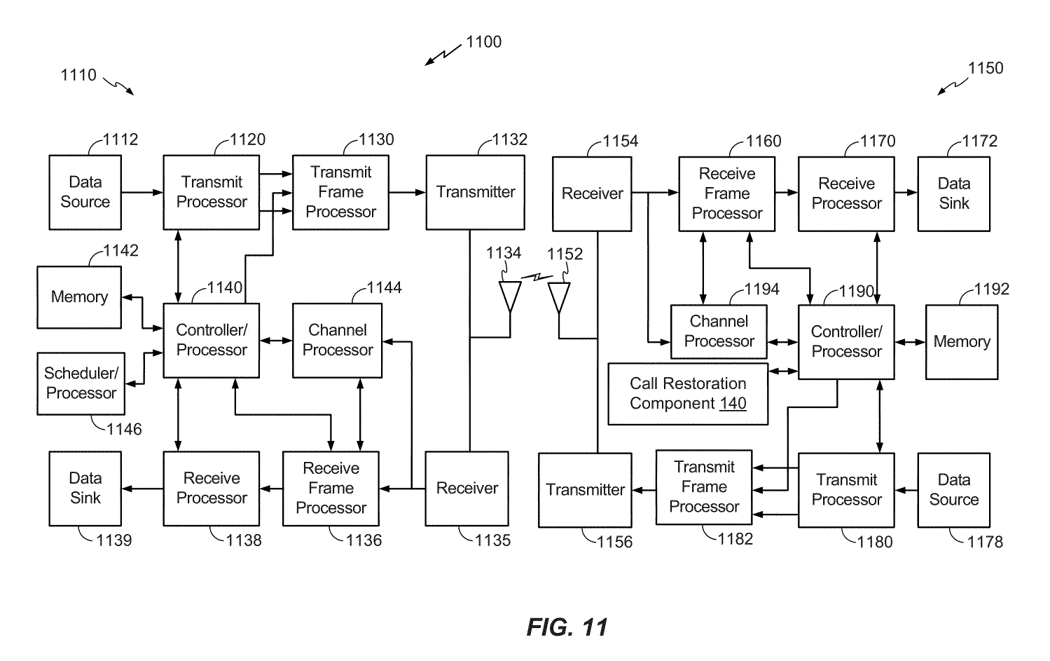

FIG. 11 is a block diagram of a communication system 1100 including a Node B 1110 in communication with a UE 1150, where Node B 1110 may be an entity within network 112 and the LIE 1150 may be UE 114 according to aspects described in FIGS. 1, 2, and 4. UE 1150 may be configured to include, for example, call restoration component 140 (FIGS. 1, 2, and 4) for optimizing the selection of a suitable cell for call recovery of a dropped call in a TD-SCDMA environment. For example, UE 1150 may implement aspects of components described above with respect to call restoration component 140, such as but not limited to, cell selection update initiating component 242, link condition determining component 244, cell selecting component 246, and call recovery component 248.

In downlink communications, a transmit processor 1120 may receive data from a data source 1112 and control signals from a controller/processor 1140. The transmit processor 1120 provides various signal processing functions for the data and control signals, as well as reference signals (e.g., pilot signals). For example, the transmit processor 1120 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 1144 may be used by a controller/processor 1140 to determine the coding, modulation, spreading, and/or scrambling schemes for the transmit processor 1120. These channel estimates may be derived from a reference signal transmitted by the UE 1150 or from feedback from the UE 1150. The symbols generated by the transmit processor 1120 are provided, to a transmit frame processor 1130 to create a frame structure, The transmit frame processor 1130 creates this frame structure by multiplexing the symbols with information from the controller/processor 1140, resulting in a series of frames. The frames are then provided to a transmitter 1132, which provides various signal conditioning functions including amplifying, filtering, and modulating the frames onto a carrier for downlink transmission over the wireless medium through antenna 1134. The antenna 1134 may include one or more antennas, for example, including beam steering bidirectional adaptive antenna arrays or other similar beam technologies.

At the UE 1150, a receiver 1154 receives the downlink transmission through an antenna 1152 and processes the transmission to recover the information modulated onto the carrier. The information recovered by the receiver 1154 is provided to a receive frame processor 1160, which parses each frame, and provides information from the frames to a channel processor 1194 and the data, control, and reference signals to a receive processor 1170. The receive processor 1170 then performs the inverse of the processing performed by the transmit processor 1120 in the Node B 1110. More specifically, the receive processor 1170 descrambles and despreads the symbols, and then determines the most likely signal constellation points transmitted by the Node B 1110 based on the modulation scheme. These soft decisions may be based on channel estimates computed by the channel processor 1194. The soft decisions are then decoded and deinterleaved to recover the data, control, and reference signals. The CRC codes are then checked to determine whether the frames were successfully decoded. The data carried by the successfully decoded frames will then be provided to a data sink 1172, which represents applications running in the UE 1150 and/or various user interfaces (e.g., display). Control signals carried by successfully decoded frames will be provided to a controller/processor 1190. When frames are unsuccessfully decoded by the receiver processor 1170, the controller/processor 1190 may also use an acknowledgement (ACK) and/or negative acknowledgement (NACK) protocol to support retransmission requests for those frames.

In the uplink, data from a data source 1178 and control signals from the controller/processor 1190 are provided to a transmit processor 1180. The data source 1178 may represent applications running in the UE 1150 and various user interfaces (e.g., keyboard). Similar to the functionality described in connection with the downlink transmission by the Node B 1110, the transmit processor 1180 provides various signal processing functions including CRC codes, coding and interleaving to facilitate FEC, mapping to signal constellations, spreading with OVSFs, and scrambling to produce a series of symbols. Channel estimates, derived by the channel processor 1194 from a reference signal transmitted by the Node B 1110 or from feedback contained in the midamble transmitted by the Node B 1110, may be used to select the appropriate coding, modulation, spreading, and/or scrambling schemes. The symbols produced by the transmit processor 1180 will be provided to a transmit frame processor 1182 to create a frame structure. The transmit frame processor 1182 creates this frame structure by multiplexing the symbols with information from the controller/processor 1190, resulting in a series of frames. The frames are then provided to a transmitter 1156, which provides various signal conditioning functions including amplification, filtering, and modulating the frames onto a carrier for uplink transmission over the wireless medium through the antenna 1152.

The uplink transmission is processed at the Node B 1110 in a manner similar to that described in connection with the receiver function at the UE 1150. A receiver 1135 receives the uplink transmission through the antenna 1134 and processes the transmission to recover the information modulated onto the carrier. The information recovered by the receiver 1135 is provided to a receive frame processor 1136, which parses each frame, and provides information from the frames to the channel processor 1144 and the data, control, and reference signals to a receive processor 1138. The receive processor 1138 performs the inverse of the processing performed by the transmit processor 1180 in the UE 1150. The data and control signals carried by the successfully decoded frames may then be provided to a data sink 1139 and the controller/processor 1140, respectively, if some of the frames were unsuccessfully decoded by the receive processor 1138, the controller/processor 1140 may also use an acknowledgement (ACK) and/or negative acknowledgement (NACK) protocol to support retransmission requests for those frames.

The controller/processors 1140 and 1190 may be used to direct the operation at the Node B 1110 and the UE 1150, respectively. For example, the controller/processors 1140 and 1190 may provide various functions including timing, peripheral interfaces, voltage regulation, power management, and other control functions. The computer readable media of memories 1142 and 1192 may store data and software for the Node B 1110 and the UE 1150, respectively. A scheduler/processor 1146 at the Node B 1110 may be used to allocate resources to the UEs and schedule downlink and/or uplink transmissions for the UEs.

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized. (EV-DO), Ultra Mobile Broadband (LIMB), IEEE 802.11 (Wi-Fi), IEEE 802.10 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

In accordance with various aspects of the disclosure, an element, or any portion of an element, or any combination of elements may be implemented with a “processing system” or processor (e.g., FIGS. 6 or 7) that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 706 (FIG. 7). The computer-readable medium 706 may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. A non-transitory computer-readable media according to aspects described herein may include machine-executable code for causing a computer to initiate a cell selection update procedure to recover a call in response to the call being dropped with a serving cell and determine link conditions of the serving cell and different candidate cells. Additionally, the code may be executable for causing a computer to select a cell, based on the link conditions, from among the serving cell and a candidate cell with a highest signal power parameter in a PCCPCH across a set of neighboring frequencies of the different candidate cells. Furthermore, the code may be executable for causing a computer to perform call recovery using the selected cell.

The computer-readable medium may also include, by way of example, a carrier wave, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 34 U.S.C. §112, sixth paragraph, or similar provisions, unless the element is expressly recited using the phrase “means for” or, in the case of a method claim, the element is recited using the phrase “step for.”

What is claimed is:

1. A method of wireless communication, comprising:
initiating a cell selection update procedure to recover a call in response to the call being dropped with a serving cell;
determining link conditions of the serving cell and different candidate cells;
selecting a cell, based on the link conditions, from among the serving cell and a candidate cell with a highest signal power parameter in a Primary Common Control Physical Channel (PCCPCH) across a set of neighboring frequencies of the different candidate cells; and
performing call recovery using the selected cell.

2. The method of claim 1, wherein the highest signal power parameter is a highest Received Signal Code Power (RSCP).

3. The method of claim 1, wherein the set of neighboring frequencies of the different candidate cells is indicated by a measurement control message before the call is dropped with the serving cell.

4. The method of claim 1, wherein determining link conditions comprises determining that an interference level on a time slot (TS) in a frame different from a first slot (TS0) in the frame for a working frequency of the serving cell, as indicated for an Interference Signal Code Power (ISCP), is greater than an interference level threshold.

5. The method of claim 4, wherein selecting a cell comprises selecting the candidate cell with the highest signal power parameter in the PCCPCH across the set of neighboring frequencies from among the different candidate cells when the interference level on the TS for the working frequency of the serving cell is greater than the interference level threshold.

6. The method of claim wherein determining link conditions comprises:
determining that an interference level on a TS in a frame different from a TS0 in the frame for a working frequency of the serving cell, as indicated for an ISCP, is less than an interference level threshold; and
determining that the signal power parameter in the PCCPCH on the TS0 for a primary frequency is greater than a signal power threshold.

7. The method of claim 6, wherein selecting a cell comprises selecting the serving cell when the interference level on the TS for the working frequency of the serving cell is less than the interference level threshold and when the signal power parameter in the PCCPCH on the TS0 for the primary frequency is greater than the signal power threshold.

8. The method of claim 1, further comprising determining that the call is dropped with the serving cell in response to an uplink (UL) Radio Link Control (RLC) error occurs or transmitting at a maximum transmission power for a specified period of time period.

9. The method of claim 8, wherein selecting a cell comprises selecting the candidate cell with the highest signal power parameter in PCCPCH across the set of neighboring frequencies from among the different candidate cells when the call is dropped with the serving cell in response to the UL RLC error or transmitting at the maximum transmission power for the specified period of time.

10. An apparatus for wireless communication, comprising:
at least one processor; and:
a memory having instructions and coupled to the at least one processor, wherein the at least one processor is configured to execute the instructions to:
initiate a cell selection update procedure to recover a call in response to the call being dropped with a serving cell;
determine link conditions of the serving cell and different candidate cells;
select a cell, based on the link conditions, from among the serving cell and a candidate cell with a highest signal power parameter in a Primary Common Control Physical Channel (PCCPCH) across a set of neighboring frequencies of the different candidate cells; and
perform call recovery using the selected cell.

11. The apparatus of claim 10, wherein the highest signal power parameter is a highest Received Signal Code Power (RSCP).

12. The apparatus of claim 10, wherein the set of neighboring frequencies of the different candidate cells is indicated by a measurement control message before the call is dropped with the serving cell.

13. The apparatus of claim 10, wherein the at least one processor configured to determine link conditions is further configured to determine that an interference level on a time slot (TS) in a frame different from the first slot (TS0) in the frame for a working frequency of the serving cell, as indicated for an Interference Signal Code Power (ISCP), is greater than an interference level threshold.

14. The apparatus of claim 13, wherein the at least one processor is further configured to select the candidate cell with the highest signal power parameter in the PCCPCH across the set of neighboring frequencies from among the different candidate cells when the interference level on the TS for the working frequency of the serving cell is greater than the interference level threshold.

15. The apparatus of claim 10, wherein the at least one processor configured to determine link conditions is further configured to:
determine that an interference level on a TS in a frame different from a TS0 in the frame for a working frequency of the serving cell, as indicated for an ISCP, is less than an interference level threshold; and
determine that PCCPCH signal power parameter on the TS0 for a primary frequency is greater than a signal power threshold.

16. The apparatus of claim 15, wherein the at least one processor is further configured to select the serving cell when the interference level on the TS for the working frequency of the serving cell is less than the interference level threshold and when PCCPCH RSCP on the TS0 for the primary frequency is greater than the signal power threshold.

17. The apparatus of claim 10, wherein the at least one processor is further configured to determine that the call is dropped with the serving cell in response to an uplink (UL) Radio Link Control (RLC) error occurs or transmitting at a maximum transmission power for an extended time period.

18. The apparatus of claim 17, wherein the at least one processor is further configured to select the candidate cell with the highest signal power parameter in PCCPCH across the set of neighboring frequencies from among the different candidate cells when the call is dropped with the serving cell in response to the UL RLC error or transmitting at the maximum transmission power for the specified period of time.

19. An apparatus for wireless communication, comprising:
means for initiating a cell selection update procedure to recover a call in response to the call being dropped with a serving cell;
means for determining link conditions of the serving cell and different candidate cells;
means for selecting a cell, based on the link conditions, from among the serving cell and a candidate cell with a highest signal power parameter in a Primary Common Control Physical Channel (PCCPCH) across a set of neighboring frequencies of the different candidate cells; and
means for performing call recovery using the selected cell.

20. The apparatus of claim 19, wherein the highest signal power parameter is a highest Received Signal Code Power (RSCP).
